(19) United States
(12) Patent Application Publication
(10) Pub. No.: US 2023/0368737 A1
(43) Pub. Date: Nov. 16, 2023

(54) GLOBAL BURN-IN COMPENSATION WITH EYE-TRACKING

(71) Applicant: Meta Platforms Technologies, LLC, Menlo Park, CA (US)

(72) Inventors: Byung Geun JUN, San Jose, CA (US); Jeong-Keun AHN, Palo Alto, CA (US); Min Hyuk CHOI, San Jose, CA (US)

(21) Appl. No.: 18/357,908

(22) Filed: Jul. 24, 2023

Related U.S. Application Data
(60) Provisional application No. 63/402,414, filed on Aug. 30, 2022.

(51) Int. Cl. G09G 3/3233; G06F 3/01

(52) U.S. Cl. CPC G09G 3/3233; G06F 3/013; G09G 2320/046

(57) ABSTRACT

Disclosed herein are methods and corresponding systems and devices for compensating burn-in in an electronic display. When the electronic display is divided into multiple regions, each region can have a separate compensation parameter associated with it. The compensation parameter can be determined through estimating pixel degradation based on how the region was used over the lifetime of the electronic display, for instance, the brightness of images previously displayed in the region. Although each region may have its own compensation parameter, burn-in compensation can be performed by selecting one compensation parameter from among a set of stored parameters for use as a global compensation parameter applied across all the display pixels, i.e., the entire display area. The global compensation parameter can be selected based on which region a user is looking at. Accordingly, a display system can include or be coupled to an eye-tracking unit that monitors eye movement.

### CROSS-REFERENCE TO RELATED APPLICATIONS

This application claims the benefit of and priority to U.S. Provisional Application No. 63/402,414, filed Aug. 30, 2022, entitled “GLOBAL BURN-IN COMPENSATION WITH EYE-TRACKING,” which is assigned to the assignee hereof and is herein incorporated by reference in its entirety for all purposes.

### TECHNICAL FIELD

The present disclosure generally relates to compensation of burn-in in electronic displays. Aspects of the disclosure also relate to burn-in compensation for displays in artificial reality systems.

### BACKGROUND

Artificial reality systems are becoming increasingly ubiquitous, with applications in many fields. In general, artificial reality is a form of reality that has been adjusted in some manner before presentation to a user. Artificial reality may include, for example, virtual reality (VR), augmented reality (AR), mixed reality (MR), hybrid reality, or some combination and/or derivatives thereof. Typical artificial reality systems include one or more devices for rendering and displaying content to users. As one example, an artificial reality system may incorporate a head-mounted display (HMD) that is worn by a user and configured to output artificial reality content to the user. During operation, the user typically interacts with the artificial reality system to select content, launch software applications, configure the system and, in general, experience artificial reality environments.

Modern display devices are often based on light emitting diode (LED) technology. Display devices in artificial reality systems tend to be smaller compared to electronic displays in other applications, such as television sets or desktop monitors. Despite being smaller, display devices in artificial reality systems are usually high-resolution, with large pixel counts and high pixel density (e.g., in pixels per centimeter) because such displays are typically viewed up close. To meet performance requirements in a small and/or portable form factor, HMDs and other display devices used in an artificial reality environment are sometimes built from micro-LEDs, which can have an LED lateral dimension of 100 micrometers or less, e.g., a diameter on the order of 10 microns or on the order of 1 micron. LED displays, especially organic LED (OLED) displays, are prone to burn-in. Burn-in is a problem in which repetitive use of the display over time (e.g., displaying the same image over thousands of hours) causes pixels to degrade to varying degrees depending on how the individual pixels were used. The degradation is characterized by loss of brightness (luminance) and sometimes manifests as a ghost image.

### SUMMARY

Aspects of the disclosure are directed to techniques for compensating burn-in in an electronic display. In particular, techniques are described herein for burn-in compensation using a global compensation parameter that can be applied to all pixels of an electronic display. The global compensation parameter is determined based on estimating pixel degradation and can be stored in memory. In some examples, a separate compensation parameter is determined for each region of a display screen divided into multiple (at least two) regions, and one of the compensation parameters is selected for use based on which region a user is looking at, as determined through eye-tracking. The example techniques can be used in conjunction with OLED or other LED based displays, but may also be applicable to other display technologies, such as liquid crystal displays (LCDs).

### BRIEF DESCRIPTION OF THE DRAWINGS

Illustrative embodiments are described in detail below with reference to the following figures.

FIG. 1 is a block diagram of an example artificial reality system environment in which one or more embodiments can be implemented.

FIG. 2 is a block diagram of a display system usable for implementing one or more embodiments.

FIG. 3 is a block diagram of a display system, according to certain embodiments.

FIG. 4 shows an example of output images produced with and without compensation.

FIG. 5A shows example luminance curves illustrating differences in the relative brightness of pixels that are subjected to higher stress compared to pixels that are subjected to lower stress.

FIG. 5B shows example luminance curves for a group of pixels over the course of several compensation operations.

FIG. 6A shows example gamma curves representing brightness as a function of the input value to a pixel.

FIG. 6B shows an example of gamma curve rescaling, according to some embodiments.

FIG. 7 shows an example of artifacts that may be produced as a result of compensation using block-averaging.

FIG. 8A shows a display screen divided into different regions, according to certain embodiments.

FIG. 8B shows an example of global burn-in compensation applied to the display screen in FIG. 8A, according to certain embodiments.

FIG. 9 shows example luminance curves for different regions of the display screen in FIG. 8A.

FIG. 10 shows example luminance curves for a group of pixels over the course of several compensation operations, according to certain embodiments.

FIG. 11 is a flow diagram of a process for burn-in compensation, according to certain embodiments.

FIG. 12 is a flow diagram of a process for switching between compensation parameters, according to certain embodiments.

FIG. 13 is a block diagram of an example electronic system usable for implementing one or more embodiments.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Burn-in is a problem for many electronic displays. Burn-in can occur when a pixel has been driven with a high luminance value (e.g., to emit the color white) for an extended period of time, e.g., thousands of hours. A pixel driven in such a manner can referred to as a high-stressed pixel. In comparison to low-stressed pixels, high-stressed pixels tend to be dimmer, exhibiting lower brightness given the same input. Because images rendered on a display are not uniformly bright or dark, the individual pixels of an LED display will degrade by different amounts over the lifetime of the display. Degradation in pixel performance can be compensated through adjusting the input signal to a pixel, e.g., by increasing the drive voltage or current beyond that which would have been used in the absence of compensation. The extent of the adjustment to the input signal depends on the extent of the pixel degradation.

In some instances, sensing circuitry may be provided to measure degradation. For example, each pixel in a display may be provided with its own sensor circuit, which can be incorporated into the circuitry forming the pixel (e.g., as part of a pixel cell). Sensor-based compensation is not always feasible. For example, smaller-size displays such as HMDs or other displays used in an artificial reality system may not have enough space to fit sensing circuitry, especially if each pixel is to be individually measured. As an alternative to sensing, pixel degradation may be estimated using a prediction algorithm. In general, sensor measurements provide a more accurate indication of degradation. However, degradation can be estimated with a reasonable level of accuracy based on collection of information regarding how each pixel has been used. For instance, in some embodiments, a display driver or controller can be configured to periodically estimate how much each pixel has degraded based on collecting information regarding frequency of use, operating temperature, luminance data (e.g., grayscale value of images displayed), and/or other factors that contribute to burn-in. The display driver may compute a value for a compensation parameter according to the degradation estimate and then store the compensation parameter in a memory for subsequent use in a compensation operation.

Ideally, each pixel in a display is individually compensated so that the amount by which the input signal to the pixel is adjusted is determined according to the amount by which the pixel has degraded. However, compensation on a per-pixel basis is not always feasible. The amount of memory needed to store compensation parameters is expected to increase in correspondence with increases in display resolution, in some cases beyond the storage capacity of available memory. For example, a display driver in an artificial reality system may be implemented as an integrated circuit that includes embedded memory used for image processing and other display-related operations. The embedded memory of the display driver may be significantly smaller in capacity (e.g., less than 10 megabytes) compared to memory available for run-time execution of an artificial reality application. For a 2000×2000 pixel display, storing a compensation parameter for each individual pixel may require several times more memory (e.g., around 100 megabytes), and that is assuming that the entirety of the embedded memory is available for storing compensation information. In practice, only a fraction of the embedded memory may be dedicated for compensation purposes.

To address the challenges discussed above, aspects of the present disclosure relate to burn-in compensation using a global compensation parameter that can be applied to all pixels of an electronic display. In some examples, a separate compensation parameter is determined for each region of a display divided into multiple regions, and one of the compensation parameters is selected for use in any given compensation operation. For example, the display may be divided into a 3×3 grid with a separate compensation parameter for each of the nine regions in the grid. The compensation parameter for a display region can be determined based on degradation information for each pixel in the region, e.g., as an average of compensation parameter values of individual pixels. In this manner, the storage requirements can be reduced significantly compared to storing a separate compensation parameter for each pixel.

Additionally, aspects of the present disclosure relate to techniques for maintaining image quality in conjunction with burn-in compensation. Compensation using a global parameter as discussed above can reduce visual artifacts compared to other compensation techniques that do not involve compensation on a per-pixel basis. For example, if each compensation parameter in the 3×3 grid were applied simultaneously, i.e., using a corresponding compensation parameter for each of the nine regions, the resulting image could contain step discontinuities due to each region being compensated in a different manner. Global compensation can make the resulting image smoother since the same parameter is applied to pixels across different regions. Other techniques for maintaining imaging quality can also be applied in addition to global compensation.

In some examples, global compensation involves selecting a compensation parameter based on eye-tracking. An artificial reality system may be configured to track the movement of one or more of a user's eyes, e.g., to determine the gaze direction of the user. A display device in an artificial reality system can leverage such eye information to apply the compensation parameter for the region where the user is currently looking (e.g., one of the nine regions in the 3×3 grid). In this manner, the burn-in compensation can prioritize the region where the user is looking, in order to improve the perceived quality of the image since the user's attention is focused on that particular region. Additional techniques for maintaining image quality are also described, such as using interpolation to gradually transition between compensation parameters in order to minimize image flicker.

Aspects of the present disclosure relate to burn-in compensation for pixels in an LED display. A pixel of an LED display can be formed using one or more light emitters, i.e., LEDs. To emit light of different colors, each pixel may include a set of emitters that collectively produce the light emitted by the pixel. For instance, a pixel can include at least one red emitter, at least one green emitter, and at least one blue emitter so that that pixel can be controlled to emit light according to an input red-green-blue (RGB) value. Accordingly, the pixel-related functionality described herein may be applied to a single emitter or to multiple emitters that form a pixel. RGB is one example of a color model that may be employed by a display system. CMYK (cyan-magenta-yellow-key black) is another example. A value expressed in terms of a color model can be separated into a luminance component and a chrominance component. The luminance component represents brightness and may, for example, correspond to a grayscale level between 0 and 255, where 0 is black (fully dark) and 255 is white (fully bright).

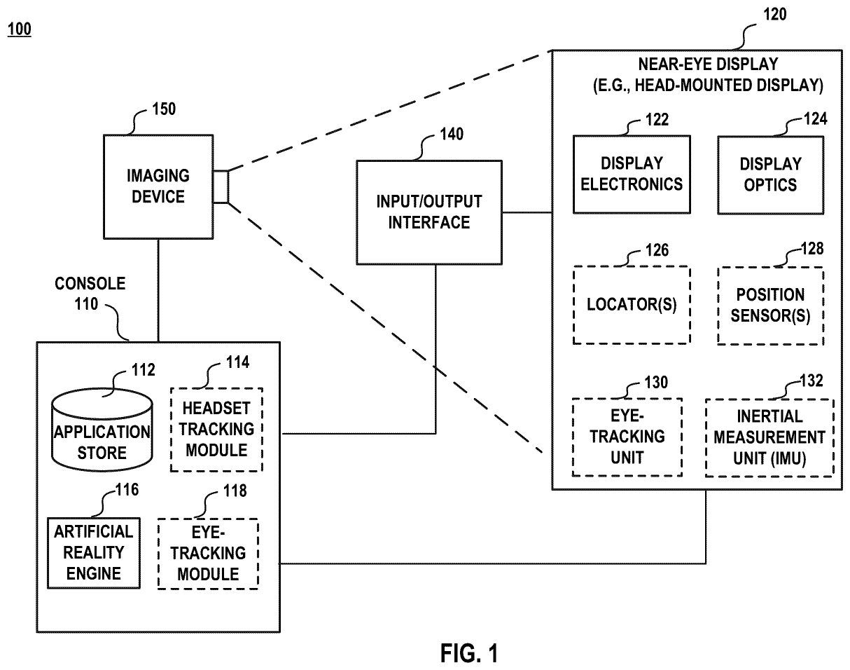

FIG. 1 is a block diagram of an example artificial reality system environment 100 in which one or more embodiments can be implemented. Artificial reality system environment 100 includes a near-eye display 120, an imaging device 150, and an input/output interface 140, each of which may be coupled to a console 110. While FIG. 1 shows an example of artificial reality system environment 100 including one near-eye display 120, one imaging device 150, and one input/output interface 140, any number of these components may be included in artificial reality system environment 100, or any of the components may be omitted. For example, there may be multiple near-eye displays 120 monitored by one or more imaging devices 150 in communication with console 110. In some implementations, artificial reality system environment 100 may not include imaging device 150, input/output interface 140, and/or console 110. In other implementations, components not depicted (e.g., different and/or additional components) may be included in artificial reality system environment 100.

Near-eye display 120 may be a head-mounted display (HMD) that presents content to a user. Examples of content that can be presented by near-eye display 120 include images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may be implemented in any form factor suitable for a particular application, including as a pair of glasses. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to the user.

In various embodiments, near-eye display 120 may include display electronics 122, display optics 124, and/or an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, various elements shown in FIG. 1 may be combined into a single element in some embodiments.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro-LED display, an active-matrix OLED display (AMOLED), a transparent OLED display

(TOLED), or some other display type. In one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels that emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

Display optics 124 may direct image light received from the display electronics 122 (e.g., using optical waveguides and couplers), magnify the image light, correct optical errors associated with the image light, and present the corrected image light to a user of near-eye display 120. In various embodiments, display optics 124 may include one or more optical elements, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain a relative spacing and orientation of the optical elements in the combination. One or more optical elements in display optics 124 may have an optical coating, such as an anti-reflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be farther from the user's eyes than the near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by imaging device 150 to determine the artificial reality headset's position, orientation, or both. A locator 126 may be an LED, a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nanometers (nm) to 750 nm), in the infrared (IR) band (e.g., about 750 nm to 1 millimeter (mm)), in the ultraviolet band (e.g., about 10 nm to about 380 nm), in another portion of the electromagnetic spectrum, or in any combination of portions of the electromagnetic spectrum.

Imaging device 150 may include one or more cameras, one or more video cameras, any other device capable of capturing images including one or more of locators 126, or any combination thereof. Additionally, imaging device 150 may include one or more filters (e.g., to increase signal to noise ratio). Imaging device 150 may be configured to detect light emitted or reflected from locators 126 in a field of view of the imaging device 150. In embodiments where locators 126 include passive elements (e.g., retroreflectors), the imaging device 150 may include a light source that illuminates some or all of locators 126, which may retro-reflect the light to the light source in imaging device 150. The imaging device 150 may communicate slow calibration data to console 110, and the imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 include accelerometers, gyroscopes, magnetometers, other motion-detecting or error-correcting sensors, or any combination thereof. In some embodiments, position sensors 128 may include multiple accelerometers to measure translational motion (e.g., forward/back, up/down, or left/right) and multiple gyroscopes to measure rotational motion (e.g., pitch, yaw, or roll).

IMU 132 may be an electronic device that generates fast calibration data based on measurement signals received from one or more position sensors 128. Position sensors 128 may be located external to IMU 132, internal to IMU 132, or both externally and internally. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye-tracking may refer to determining an eye's position, including orientation and location of the eye relative to near-eye display 120. An eye-tracking system may include an imaging system to image one or more eyes and may optionally include a light emitter, which may generate light that is directed to an eye such that light reflected by the eye is captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130).

Near-eye display 120 may use the orientation of the eye to, e.g., determine an inter-pupillary distance (IPD) of the user, determine gaze direction, introduce depth cues (e.g., blur an image outside of the user's main line of sight), collect information on user interactions (e.g., time spent on any particular subject, object, or frame as a function of exposed stimuli), and/or perform other operations based on the orientation of at least one of the user's eyes. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be configured to allow a user to send action requests to console 110. For example, an action request may be to start or to end a software application or to perform a particular action within the software application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received or when console 110 has performed a requested action. In some embodiments, an imaging device 150 may be used to track the input/output interface 140 and/or track the user's hand movement. For example, near-eye display 120 may include an imaging device 150 that tracks the location or position of a hand-held controller (e.g., using a light source on the controller) so that the user's hand movement can be inferred from changes in the location or position of the controller.

Console 110 may provide content to near-eye display 120 for presentation to the user in accordance with information received from imaging device 150, near-eye display 120, and/or input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functionality may also be distributed among components of console 110 in a different manner than is described here.

One or more components of the artificial reality system environment 100 (e.g., the console 110) may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions that, when executed by the processor, cause the processor to perform operations in accordance with the techniques described herein.

In general, any component in the artificial reality system environment 100 that processes data may include one or more processing units and/or one or more memory devices. Besides the console 110, such components may include the near-eye display 120, the input/output interface 140, and/or the imaging device 150. Examples of processing units include a central processing unit (CPU), a graphics processing unit (GPU), a field programmable gate array (FPGA), and integrated circuits. In some embodiments, at least some processing units are implemented as a System on Chip (SoC). For example, console 110 and near-eye display 120 may each include one or more SoCs operating as co-application processors, sensor aggregators, display controllers, encryption/decryption engines, hand/eye/depth tracking and pose computation elements, video encoding and rendering engines, communication control components, and/or the like. In one example, near-eye display 120 may include a first SoC operating as a display driver/controller for a left display, a second SoC operating as a display controller for a right display, and a third SoC operating as the eye-tracking unit 130.

Application store 112 may store one or more applications for execution by console 110. An application may include instructions that, when executed by a processor, generates content for presentation to the user. Content generated by an application may be in response to inputs received from the user via movement of the user's eyes or inputs received from the input/output interface 140. Examples of applications that may be in the application store 112 include gaming applications, conferencing applications, video playback applications, and/or other applications suitable for execution in an artificial reality environment.

Headset tracking module 114 may track movements of near-eye display 120 using slow calibration information from the imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future position of near-eye display 120. Headset tracking module 114 may provide the predicted position of the near-eye display 120 to the artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140 and provide feedback to the user indicating that the action has been performed. The feedback may be visual or audible feedback presented via near-eye display 120 or haptic feedback presented via input/output interface 140.

Eye-tracking module 118 may receive eye-tracking data from eye-tracking unit 130 and determine the position of the user's eye based on the eye tracking data. Eye position may include an eye's orientation, location, or both relative to near-eye display 120 or any element thereof. In addition or as an alternative to eye tracking and headset tracking, one or more components of the artificial reality system environment 100 may be configured to track other features of the user and/or aspects of the physical environment external to near-eye display 120.

As discussed above, display electronics 122 may include one or more display panels (screens). Display electronics 122 may further include one or more display controllers, e.g., a separate controller for each display panel or a shared controller for multiple display panels. A display panel can include one or more arrays of emitters arranged into rows and columns. For example, a display panel can include an array of red LEDs, an array of green LEDs, and an array of blue LEDs. The display controller(s) of the display electronics 122 may be configured to perform burn-in compensation using stored compensation information which, according to certain aspects of the present disclosure, can include a set of compensation parameters associated with different display regions.

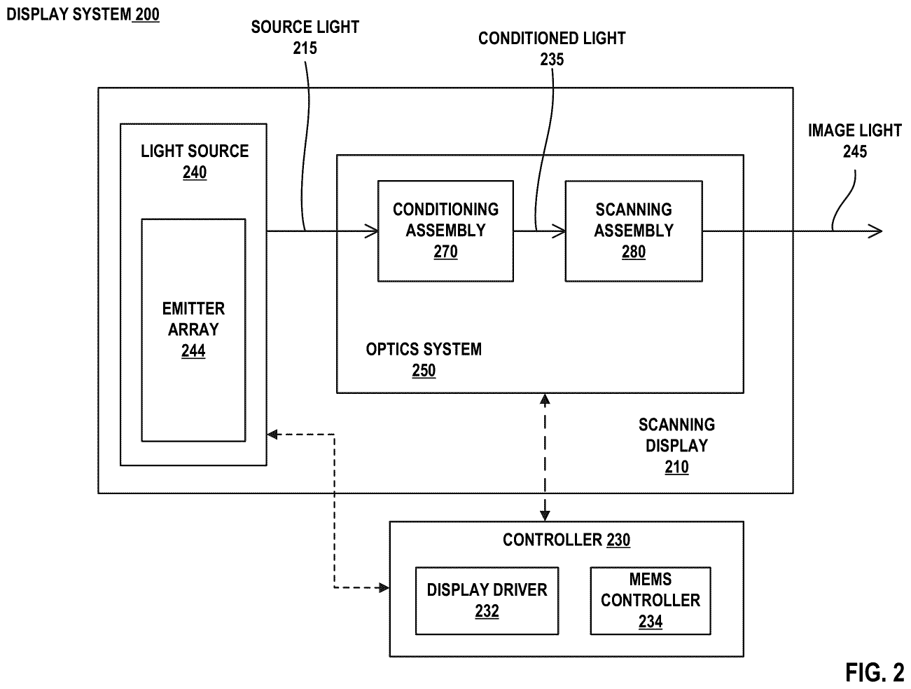

FIG. 2 is a block diagram of a display system 200 usable for implementing one or more embodiments. The display system 200 may correspond to an implementation of the near-eye display 120 in FIG. 1 and includes a scanning display 210, a controller 230, a light source 240, and an optics system 250. The display system 200 is an example of a display environment in which light produced by the emitters in the display is not viewed directly but is instead processed using optical components to form an output image for display to a user.

Scanning display 210 generates image light 245 in accordance with scanning instructions from the controller 230. The scanning display 210 includes a light source 240 and an optics system 250. The light source 240 is a source of light that generates a spatially coherent or a partially spatially coherent source light 215, e.g., an image or partial image. The optics system 250 includes a conditioning assembly 270 and a scanning assembly 280. The conditioning assembly 270 transforms the source light 215 into conditioned light 235, and the scanning assembly 280 scans the conditioned light 235. The image light 245 may be coupled to an entrance of an output waveguide (not shown) to direct the image light 245 toward an eye of the user.

Light source 240 emits light in accordance with image data in the form of one or more illumination parameters received from the controller 230. An illumination parameter is used by the light source 240 to generate light. An illumination parameter may include, e.g., source wavelength, pulse rate, pulse amplitude, beam type (continuous or pulsed), other parameter(s) that affect the emitted light, or some combination thereof. The illumination parameter can be applied to an emitter of the light source 240 using analog and/or digital signals that drive the light source, e.g., to a luminance signal that sets the brightness of an emitter based on the voltage or current level of the luminance signal. The illumination parameter and/or other image data can be supplied from the controller 230 to circuitry that generates, based on the image data, the signals which drive the light source. This driving circuitry can be included in the light source 240 (e.g., co-located with emitters of the light source) or located external to the light source 240.

Light source 240 includes a set of emitters, where each emitter may be, e.g., a light-emitting diode (LED), a laser diode, a vertical cavity surface emitting laser (VCSEL), an organic LED (OLED), a micro-LED, a tunable laser, or some other light source that emits coherent or partially coherent light. The emitters of the light source 240 emit light in a visible band (e.g., from about 390 nm to 700 nm). In some embodiments, the scanning display 210 comprises multiple light sources, each with its own array of emitters emitting light in a distinct wavelength such that when scanned, light emitted from each of the light sources are overlapped to produce various wavelengths in a spectrum. Each emitter of the light source 240 includes an emission surface from which a portion of source light is emitted. The emission surface may be identical for all emitters or may vary between emitters. The emission surface may have different shapes (circular, hexagonal, etc.).

The emitters of the light source 240 can be arranged as an array 244, which can be one-dimensional (1D) or two-dimensional (2D). In a 2D array, the emitters are formed along a first dimension and a second dimension orthogonal to the first dimension (e.g., along rows and columns). Each column of emitters corresponds to a respective column in an image ultimately displayed to the user. The emitters may be of various colors. For example, the light source 240 may include a set of red emitters, a set of green emitters, and a set of blue emitters, where emitters of different color together form an individual pixel. An individual pixel may include at least one red emitter, at least one green emitter, and at least one blue emitter. Rows of emitters of the same color may be arranged in a single group. For example, the array may comprise N rows of red emitters followed by N rows of green emitters and then N rows of blue emitters.

Light source 240 may include additional components such as data shifting circuits and driving circuits, which are electrically coupled to the emitter array 244. The data shifting circuits may supply image data from the controller 230 to the driving circuits, which then generate signals that activate the emitters. For example, image data can be sequentially shifted through a row or column of emitters to form a display image, with the resulting emitted light being scanned to form an output image. The driving circuits include circuitry for controlling the array of emitters based on the image data. For example, the driving circuits may apply illumination parameters received from the controller 230 (e.g., luminance values received from a display driver of the controller) to control each emitter in the array of emitters using analog and/or digital control signals. The emitters can be controlled using electric currents (current-mode control) or voltages (voltage-mode control). In some embodiments, the emitters are controlled using pulse-width modulation (PWM), amplitude adjustments, or a combination of both.

Conditioning assembly 270 conditions the source light 215 produced by the light source 240. Conditioning the source light 215 may include, e.g., expanding, collimating, focusing, distorting emitter spacing, adjusting orientation an apparent location of an emitter, correcting for one or more optical errors (e.g., field curvature, chromatic aberration), some other adjustment of the light, or some combination thereof. Accordingly, the conditioning assembly 270 may include one or more optical elements such as lenses, mirrors, apertures, gratings, or any other suitable optical element that affects image light.

Scanning assembly 280 includes one or more optical elements that redirect light via one or more reflective portions of the scanning assembly 280. The direction where the light is redirected toward depends on specific orientations of the one or more reflective portions. The one or more reflective portions of the scanning assembly may form a planar or curved surface (e.g., spherical, parabolic, concave, convex, cylindrical, etc.) that operates as a mirror. The scanning assembly 280 scans along at least one dimension of a 2D emitter array, through rotation about a predetermined axis. In some embodiments, the scanning assembly 280 is configured to scan in at least the smaller of the two dimensions. For example, if the emitters are arranged in a 2D array where the rows are substantially longer (i.e., contain more emitters) than the columns, then the scanning assembly 280 may scan down the columns (e.g., row by row or multiple rows at a time). In other embodiments, the scanning assembly 280 may perform a raster scan (horizontally or vertically depending on scanning direction). The scanning assembly 280 can include multiple scanning minors, each of which is configured to scan in 0, 1, or 2 dimensions. The scanning can be controlled using one or more microelectromechanical systems (MEMS) devices, such as electrostatic or electromagnetic actuators, included in the optics system 250.

Controller 230 controls the light source 240 and the optics system 250. The controller 230 takes content for display and divides the content into discrete sections. The controller 230 instructs the light source 240 to sequentially present the discrete sections using individual emitters corresponding to a respective row or column in an image ultimately displayed to the user. The controller 230 instructs one or both of the conditioning assembly 270 and the scanning assembly 280 to condition and/or scan the discrete sections. The controller 230 controls the optics system 250 to direct the discrete sections of the image light 245 to different areas, e.g., to different coupling points of a waveguide. Accordingly, each discrete portion may be presented in a different location and at different times such that the full output image is rendered as a sequence of partial images. While each discrete section is presented at different times, the presentation and scanning of the discrete sections can occur fast enough such that a user's eye integrates the different sections into a single image or series of images. The controller 230 also provides illumination parameters (e.g., luminance values) for the light source 240.

The controller 230 may include software and/or hardware components that control the scanning assembly 280 in synchronization with controlling the light source 240. For example, the controller 230 may include one or more computer processors, a dedicated graphics processor, application-specific integrated circuits, software programs containing instructions for execution by the one or more computer processors, etc. In some embodiments, the controller 230 includes a display driver 232 and a separate MEMS controller 234. The display driver 232 can be implemented as an integrated circuit that generates control signals for the light source 240 based on instructions from a processor executing a software application that generates the images to be displayed. For example, the software application can be an application that generates an AR or VR presentation for viewing on an HMD. The MEMS controller 234 may include circuitry that generates control signals for one or more MEMS devices that drive the rotation of the scanning assembly 280. The display driver 232 and the MEMS controller 234 may be communicatively coupled to one another to facilitate the synchronization of output from the display driver 232 with output from the MEMS controller 234. In some embodiments, the controller 230 includes timing circuitry such as a clock generator that produces one or more clock signals which determine the timing of the outputs of the display driver 232 and the MEMS controller 234. The clock signals may, for example, determine various operational phases for the output of instructions to the light source 240 and/or the output of instructions to the MEMS devices.

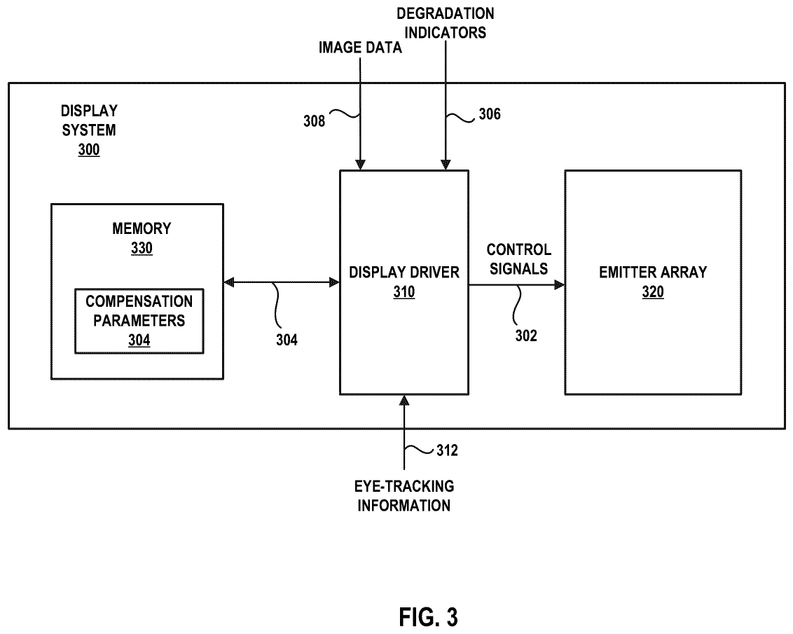

FIG. 3 is a block diagram of a display system 300 according to some embodiments. FIG. 3 is a simplified diagram depicting components that are relevant to burn-in compensation. Display system 300 is shown as including a display driver 310, an emitter array 320, and a memory 330. However, the display system 300 may include additional or fewer components. For example, display system 300 may correspond to the display system 200, in which case display system 300 could include a scanning assembly, among other things.

Display driver 310 is analogous to the display driver 232 in FIG. 2 and is configured to control the operation of the emitter array 320 using control signals 302. The display driver 310 generates the control signals 302 based on image data 308 that can be supplied from a processor (e.g., a CPU or GPU) in connection with execution of a software application. Display driver 310 may also generate the control signals 302 based on compensation parameters 304 retrieved from the memory 330. The display driver 310 may periodically update the compensation parameters 304 as the pixels of the emitter array 320 degrade over time.

Memory 330 includes one or more memory devices accessible to the display driver 310. The memory device(s) that form the memory 330 can include volatile memory, non-volatile memory, or a combination of volatile and non-volatile memory. For example, in some implementations, the display driver 310 is an integrated circuit with embedded flash memory as the memory 330. In some implementations, the memory 330 and the display driver 310 are co-located in an integrated circuit, e.g., an SoC integrated circuit. In addition to storing the compensation parameters 304, the memory 330 can include working memory for storage of data generated by the display driver 310 in connection with image-related processing.

Compensation parameters 304 are parameters with values that are correlated to the degradation of the pixels (individual emitters or groups of emitters) in the emitter array 320. In some implementations, the values of the compensation parameters 304 correspond to stress metrics that directly express the stress levels of the pixels. Alternatively, the compensation parameter values may represent the extent to which the control signals 302 are to be adjusted in consideration of the stress levels, e.g., coefficients of a mathematical function used to compute the value of a control signal. As discussed above, storing a separate compensation parameter for each pixel can be memory intensive. To reduce the amount of memory needed to store the compensation parameters 304, the display driver 310 may compute each compensation parameter to represent the stress level of multiple pixels. For example, the compensation parameters 304 can include a set of values for different regions of a display formed by the emitter array 320. Each region may be assigned a corresponding compensation parameter that is determined by the display driver 310 based on degradation indicators 306. A compensation parameter for an individual region may be computed as a function (e.g., an average) of the compensation parameters for the pixels in the region. Alternatively, the display driver 310 may compute a region-specific compensation parameter using the degradation indicators 306 that are relevant to the pixels in the region, without computing pixel-specific compensation parameters. In some embodiments, the information that the display driver 310 uses to compute the compensation parameters 304 (e.g., at least some of the degradation indicators 306) may also be stored in the memory 330.

Degradation indicators 306 can include data characterizing one or more factors that contribute to burn-in. More generally, degradation indicators 306 can include any type of information that can be used to determine the conditions under which the emitter array 320 has been or is being operated. In some instances, the degradation information is supplied through communication between the display driver 310 and an external source, for example, readings from a temperature sensor. Alternatively or additionally, the degradation indicators 306 can include information generated by the display driver 310. For example, the display driver 310 may be configured to accumulate historical data regarding how long each pixel has been used (e.g., number of hours of on-time), usage frequency (e.g., average on-time), and the brightness of the image data 308 (e.g., average luminance or grayscale value for each pixel over the course of multiple image frames). The historical data can include statistical data such as a histogram for each pixel or each display region.

The display driver 310 may be configured to execute an algorithm to estimate the degradation of each pixel and/or each display region as a function of the degradation indicators 306. In some embodiments, display driver 310 may be configured to apply a model of the pixel degradation. The display driver 310 can update the model over time to reflect changes in the way the pixels are driven, for example, to account for adjustments to the voltage or current level of a control signal as a result of a calibration operation. The display driver 310 may periodically calculate and store the compensation parameters 304, for example, every 10 minutes. In this manner, the compensation parameters 304 can be kept updated to reflect the estimated degradation of the pixels over the lifetime of the display system 300.

To generate the control signals 302, the display driver 310 may first determine a set of uncalibrated control signals based on the image data 308 for the next image to be displayed. The display driver 310 may then select one of the compensation parameters 304 to adjust the uncalibrated control signals in a uniform manner (globally) across all the pixels in the emitter array 320. The display driver 310 can select a compensation parameter that is associated with the display region that the user is currently viewing. The display region being viewed can be communicated to the display driver 310 as eye-tracking information 312. The eye-tracking information 312 can be generated through tracking movement of one or both of the user's eyes, e.g., using the eye-tracking unit 130 in FIG. 1. The eye-tracking information 312 can be in the form of a gaze direction and can be mapped to a display region. In some embodiments, the eye-tracking unit 130 is responsible for determining which display region the user is looking at. For example, the eye-tracking unit 130 may be configured to identify a pixel coordinate that is intersected by a ray traced along the gaze direction. Thus, the eye-tracking information 312 may include information identifying a display region. Alternatively, the determination of which display region the user is looking at can be performed by the display system 300, e.g., through processing at the display driver 310.

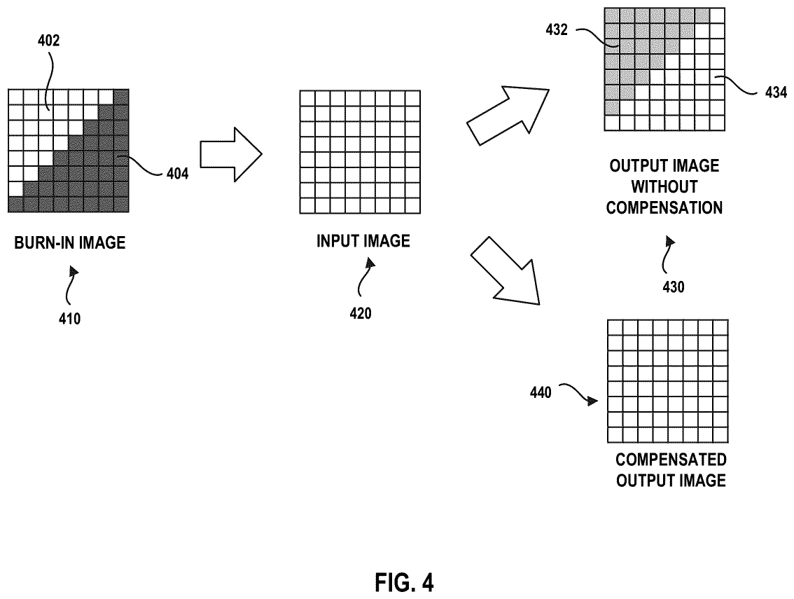

FIG. 4 shows an example of output images produced with and without compensation. In FIG. 4, a burn-in image 410 is rendered on a display for a period of time sufficient to cause the pixels of the display to degrade. For example, the burn-in image 410 may be presented continuously or periodically for a total of several thousand hours. As shown, the burn-in image 410 is non-uniform and divided into a bright region 402 (e.g., white-colored) and a dark region 404 (e.g., black-colored). Subsequently, an input image 420 is presented on the display. The input image 420 is uniformly bright and may consist of pixels that have the same color (e.g., white). In the absence of compensation, the resulting image produced on the display based on the input image 420 may be an output image 430. The burn-in image 410 is shown as an 8 pixel by 8 pixel image for simplicity. In practice, images tend to much larger.

The output image 430 in the absence of compensation is expected to be non-uniformly bright in correspondence with the non-uniformity of the burn-in image 410. As shown in FIG. 4, the brightness of the pixels in the output image 430 has an inverse relationship with the brightness of the pixels in the burn-in image 410. Pixels of the burn-in image that are brighter (the region 402) are subjected to a higher level of stress than pixels that are darker (the region 404). Accordingly, the output image 430 may include a region 432 and a region 434 corresponding to the region 402 and the region 404, respectively. The region 432 of the output image 430 is darker compared to the region 434 due to the pixels of the region 432 having been subjected to higher stress. Further, although the region 434 is brighter, the pixels in the region 434 may also be degraded, but to a lesser degree than the pixels in the region 432. Therefore, even the region 434 may be darker compared to the input image 420.

FIG. 4 also shows an output image 440 corresponding to an image that would be produced based on the input image 420 if the display were fully compensated. The output image 440 is essentially indistinguishable from the input image 420. To produce the output image 440, the display may be compensated by individually adjusting the brightness of each pixel on the display. As discussed above, compensation on a per-pixel basis is not always feasible. However, a reasonable approximation of the input image 420 may be generated without resorting to compensation of individual pixels, through applying the global compensation techniques disclosed herein.

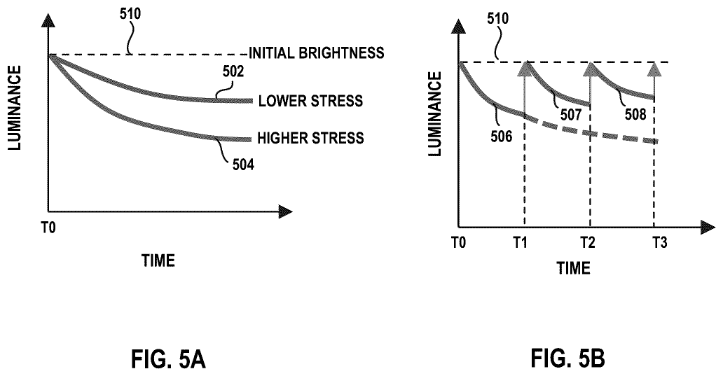

FIG. 5A shows example luminance curves illustrating differences in the relative brightness of pixels that are subjected to higher stress (luminance curve 504) compared to pixels that are subjected to lower stress (luminance curve 502). At time T0, the pixels of the display have not yet been degraded and their brightness levels may correspond to an initial brightness level 510 when the display is first put into use or just after the display has been manufactured. After an extended period of use, e.g., 10,000 hours, the pixels that have been subjected to lower cumulative stress will have degraded to a lesser degree than the pixels that have been subjected to higher cumulative stress. Thus, pixels that are subjected to higher stress will become increasing dimmer over time compared to lower-stressed pixels. In any case, given enough time, all the pixels are expected to experience some decrease in brightness relative to the initial brightness level 510.

FIG. 5B shows example luminance curves for a group of pixels over the course of several compensation operations. In this example, the display is operated in a similar manner as discussed above with respect to the higher stressed pixels in the example of FIG. 5A. Accordingly, the pixels may degrade according to a luminance curve 506 that is similar to the curve 504. For illustration purposes, the discussion of FIG. 5B is limited to these higher stressed pixels. As indicated by the dotted portion of the luminance curve 506, the degradation of the pixels will follow a similar trajectory as the luminance curve 504 in the absence of any compensation. However, in this example, a first compensation operation is performed at time T1 to bring the pixels back to the initial brightness level 510. After the compensation operation is performed, the pixels will resume degrading to decrease in brightness starting once again from the initial brightness level 510. Similarly, a second compensation operation and a third compensation operation are performed at time T2 and time T3, respectively, each time to bring the pixels back to the initial brightness level 510.

In some embodiments, compensation may be performed periodically whenever the display is in use, e.g., every ten minutes. FIG. 5B shows the pixels degrading in the same manner following each compensation operation. A luminance curve 507 between T1 and T2 and a luminance curve 508 between T2 and T3 may have a similar profile as the luminance curve 506. However, depending on how the pixels are driven, the pixels may follow a different degradation trajectory after each compensation operation. Accordingly, in some embodiments, the display system may update a degradation model after each compensation operation to account for differences between the manner in which pixels are driven before and after the compensation operation.

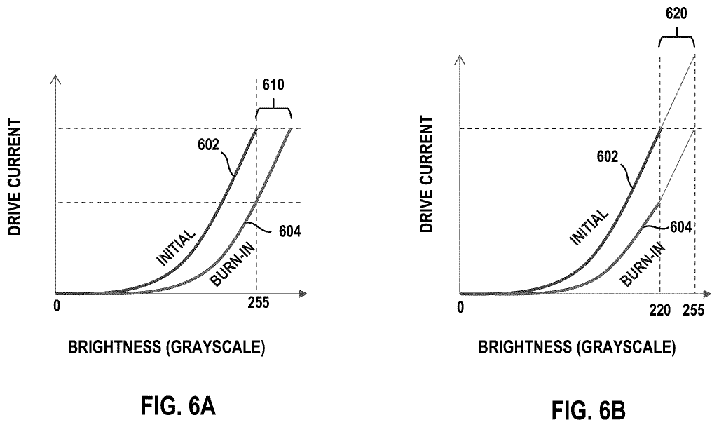

FIG. 6A shows example gamma curves representing brightness as a function of the input value to a pixel. The brightness levels may be expressed digitally and, in this example, are grayscale values ranging from 0 to 255. Thus, a total of 256 brightness levels are possible. The pixel input in this example is a drive current. Other types of input may be used depending on how the display is implemented. For example, the emitters in the display may be voltage-controlled. As shown in FIG. 6A, the display system may be configured with an initial gamma curve 602 that maps each brightness (grayscale) level to a corresponding drive current.

FIG. 6A illustrates another challenge to burn-in compensation, due to the fact that after a pixel has degraded, the pixel should no longer be controlled in the same manner. To compensate for burn-in, the input is increased in order to achieve the same brightness as would be produced when the pixel is non-degraded. For example, to produce a brightness associated with grayscale 255, a lower drive current may be applied initially in accordance with an initial gamma curve 602. After burn-in, a higher drive current (or voltage) may be applied and the gamma curve 602 may be replaced with a gamma curve 604 in which the grayscale values are mapped to current values different from the initial mapping. However, this may require adding more grayscale values to fully represent the gamma curve 604. Although the display system may be capable of producing a higher input, there is a limit on the number of brightness levels that can be represented digitally (e.g., 256 levels). To address this problem of limited digital representation, the gamma curve 604 can be extended through rescaling as shown in FIG. 6B.

FIG. 6B shows an example of gamma curve rescaling, according to some embodiments. In FIG. 6B, the post-burn-in gamma curve 604 has been rescaled so that a current level that initially mapped to grayscale 255 now maps to a lower grayscale value (e.g., 220). The rescaling effectively extends the gamma curve along the input axis (e.g., drive current/voltage) while compressing the gamma curve along the brightness axis so that a portion 610 of the gamma curve 604 in FIG. 6A that would have exceeded the maximum grayscale value of 255 fits within the 0 to 255 grayscale range, e.g., to cover a portion 620 ranging from 220 to 255. In this manner, an 8-bit grayscale encoding can be maintained so that the display system continues to operate based on 256 grayscale levels, without the need for additional bits of representation after the display has been compensation for burn-in.

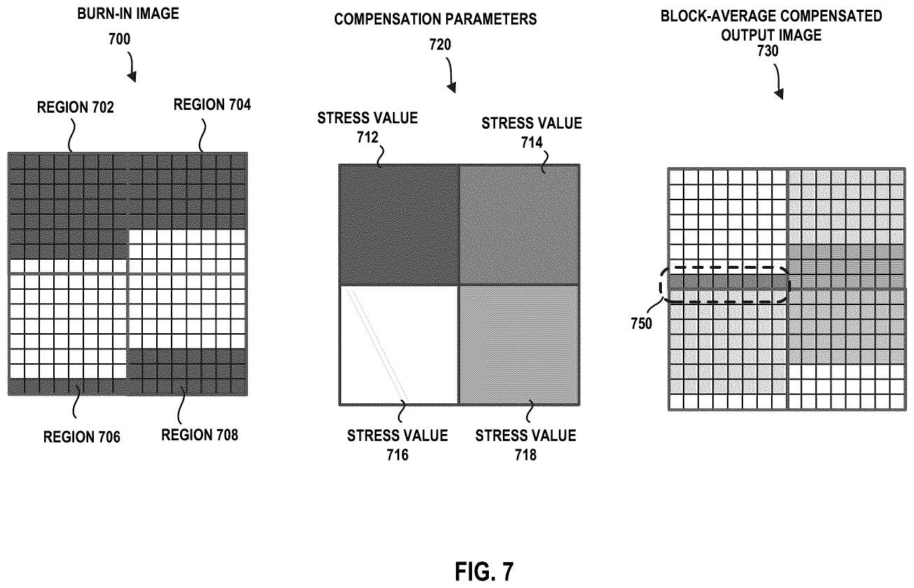

FIG. 7 shows an example of artifacts that may be produced as a result of compensation using block-averaging. In FIG. 7, a burn-in image 700 is presented on a display for an extended period of time to cause the pixels of the display to degrade non-uniformly. As with the burn-in image 410 in FIG. 4, the burn-in image 700 is a simplified representation of a display image that might be used in practice. In the example of FIG. 7, the burn-in image 700 is a 16×16 image divided into four 8×8 regions 702, 704, 706, and 708. Block-averaging based on an 8×8 block size is applied separately to each of the four regions to compute a corresponding compensation parameter for each region. In particular, a stress value 712 is computed for region 702, a stress value 714 is computed for region 704, a stress value 716 is computed for region 706, and a stress value 718 is computed for region 708. The stress values 712, 714, 716, and 718 are depicted visually as shaded blocks, but may be represented numerically for purposes of determining the extent of a compensation adjustment.

Burn-in image 700 is non-uniform. Of the four regions, the region 706 has the greatest number of bright pixels, followed by region 708, region 704, and lastly region 702. Accordingly, the pixels of the region 706 are subjected to the most stress compared to the other regions. Compensation parameters 720 can be computed by averaging stress values of pixels based on a configured block size. In this example, the block-averaging is performed for an 8×8 block. Thus, the stress value 712 may correspond to an average of the stress values for the pixels in the region 702. Similarly, the stress values 714, 716, and 718 may correspond to averages of the stress values for the pixels in the region 704, the region 706, and the region 708, respectively. Since the pixels in the region 706 are subjected to the most stress, the stress value 716 may be higher than the other stress values. For example, the stress values in descending order from highest to lowest may be the stress value 716 (shown as lightest), followed by the stress value 718, the stress value 714, and lastly the stress value 712 (shown as darkest).

When an input image is subsequently displayed using the compensation parameters 720 to compensate for the degradation produced by the burn-in image 700, the resulting output image may have visual artifacts. For example, when a uniformly bright (e.g., completely white) input image similar to the input image 420 in FIG. 4 is displayed, a block-average compensated output image 730 may be produced. The block-average compensation is applied uniformly for each pixel in a given region. Since each region is compensated by applying its corresponding stress value, the region 706 will have the greatest amount of adjustment. Although the pixels in any particular region are compensated in the same manner, the brightness of the pixels will still be non-uniform. Taking the region 706 as an example, output image pixels corresponding to bright areas of the region 706 in the burn-in image 700 will be slightly darker compared to output image pixels corresponding to dark areas of the region 706, due to having degraded more. Further, it can be seen in a circled area 750 that some pixels in the region 702 are not as well-compensated compared to neighboring pixels in the region 706, appearing much darker in comparison. This is because the stress value 712 that was applied to the region 702 is a value that represents a lower level of stress, so the pixels of the region 702 are adjusted to a lesser extent compared to the pixels of the other regions 704, 706, and 708. Therefore, the brightness of the pixels in output image 730 can vary significantly, seen most noticeably as brightness discontinuities between adjacent regions, but also within individual regions. For example, the area 750 circled in the output image 730 comprises pixels that have a step function luminance.

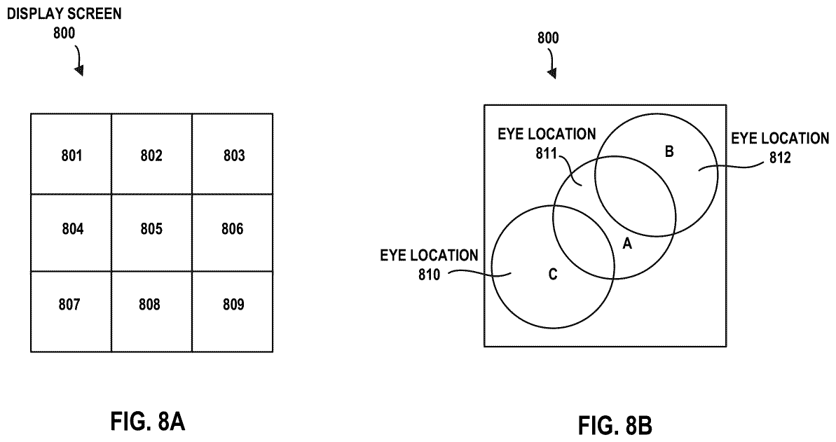

FIGS. 8A and 8B show an example of global burn-in compensation, according to certain embodiments. In FIG. 8A, a display screen 800 is conceptually divided into multiple regions. For example, display screen 800 may be an LED panel that is separated into nine regions 801 to 809 for purposes of burn-in compensation. In this example, each region is a square block. However, the size, shape, or total number of the regions may depend on implementation. Each of the regions 801 to 809 is assigned a corresponding compensation parameter. For example, the regions may be assigned stress values using the block-averaging technique described above in conjunction with FIG. 7. Further, the block-averaging may, in some embodiments, be performed based on a configurable block size (e.g., 3×3, 5×5, or 7×7 blocks). However, unlike the block-averaging compensation depicted in FIG. 7, each region 801 to 809 is not individually compensated. Instead, a single compensation parameter is used at any given time to compensate pixels across all nine regions of the display screen 800. Thus, the extent to which the input (e.g., drive current) to a pixel is adjusted may be the same across all of the regions 801 to 809.

Selecting a single compensation parameter from among a small set of compensation parameters has certain advantages, including reduction of the memory size needed to store the set of compensation parameters. For example, if non-global compensation requires storage on the order of 1 megabyte (e.g., 12 megabits), global compensation may reduce the storage requirements to somewhere on the order of 10 to 1000 bytes (e.g., 0.1 to 10 kilobits). Another advantage is lower power consumption. Since less information is processed to perform a compensation operation, the size and complexity of the logic for performing the compensation (e.g., circuitry in the display driver) can be reduced, which not only saves power but also saves space in the physical layout of the display driver or system.

Additionally, because every pixel can be compensated in the same manner, the likelihood of unintended brightness contrast between neighboring pixels is low. For example, global compensation may reduce the occurrence of discontinuities like the area 750 in FIG. 7 or avoid such discontinuities altogether. Global compensation can be performed in combination with other techniques to improve the quality of the output image and/or the performance of the display system. Examples of such additional techniques include gamma curve rescaling as discussed above in connection with FIGS. 6A and 6B and, as discussed below, reducing the extent of the brightness adjustment to less than that which would bring a pixel back to 100% of its initial brightness.

In some embodiments, the compensation parameter that will be used to produce a given output image is selected based on eye-tracking. FIG. 8B shows a user looking at different regions of the display screen 800 over time. As shown, the user's eye moves between a first eye location (A) 810, a second eye location (B) 811, and a third eye location (C) 812. For example, the user's eye may move from location 810 to location 811 and then location 812. As another example, the user's eye may jump from location 810 to location 812 and then location 811. Thus, the user's attention may be focused on different regions of the display screen 800 over the course of one or more images being presented. A compensation parameter associated with the display region where the user is currently looking (e.g., one of the regions 801 to 809) can be used to generate an output image for display to the user.

In FIG. 8B, the locations 810-812 are depicted as circular, in contrast to the rectangular (e.g., square) regions 801-809 into which the display screen 800 is divided. This is to indicate that there is not necessarily a one-to-one correspondence between the location of the user's eyes (or a single eye in some instances) and the display regions. For example, the size of each eye location could depend on the precision of the eye-tracking. Pixel level precision is not required for global compensation and may not be realistically achievable for a typical eye-tracking unit. Thus, the radius of the locations 810-812 may represent the uncertainty in the exact display position that the user's eyes are focused on. Further, the eye location may not fully coincide with a single display region. For example, one or more of the locations 810-812 may overlap multiple display regions 801-809. The regions 801-809 can be configured in accordance with the precision of the eye-tracking and so that a single display region can be definitively identified as being the region where the user is looking. For example, the regions 801-809 can be sized so that a majority of the pixel positions in the area around the eye location (e.g., more than 50% of the pixels in location 810) will fall within one of the regions 801-809.

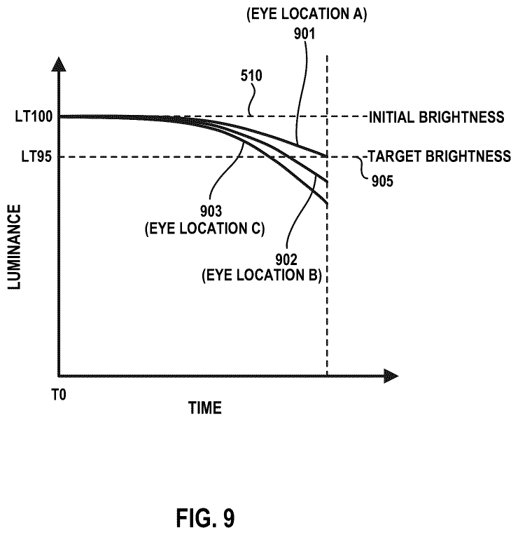

FIG. 9 shows example luminance curves for different regions of the display screen 800. A first luminance curve 901 represents the brightness degradation experienced by pixels corresponding to eye location A in FIG. 8B. A second luminance curve 902 represents the brightness degradation experienced by pixels corresponding to eye location B. Similarly, a third luminance curve 903 represents the brightness degradation experienced by pixels corresponding to eye location C. As with the example in FIG. 5, all of the pixels may start at the same level of brightness performance (initial brightness level 510). Over time, the pixels will degrade non-uniformly. Comparing the curves 901, 902, and 903, it can be seen that pixels corresponding to location C experience the most degradation over the course of display operation, while pixels corresponding to location A experience the least degradation.

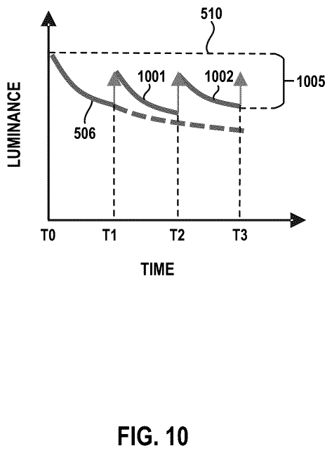

One option for compensating burn-in is to adjust the pixel input to bring the pixels back to their initial performance, e.g., brightness level 510 as shown in the example of FIG. 5B. The brightness level 510 may be a luminance value specified by a manufacturer of the display screen or the emitters that form the pixels of the display screen and is labeled LT100 in FIG. 9 to denote that the brightness level 510 corresponds to 100% of the specified brightness over the lifetime of the display. However, in some situations it may be desirable to compensate less than fully, e.g., so that the pixels are driven to achieve a target brightness 905 that is 95% (LT95) of the LT100 brightness. One reason for less than full compensation is power savings. As pixels degrade progressively, the amount of power required to bring the pixels back to their initial brightness will grow in correspondence with the degradation. Additionally, as discussed below in connection with FIG. 10, another reason to compensate less than fully is to improve the quality of the output image by rendering the output image in a way that minimizes the appearance of ghost images.

FIG. 10 shows example luminance curves for a group of pixels over the course of several compensation operations. The compensation operations are performed at times T1, T2, and T3, resulting in a luminance curve 1001 after the compensation at T1, and a luminance curve 1002 after the compensation at T2. Depending on the frequency with which compensation is performed, the duration between compensation operations may be uniform (e.g., spaced every ten minutes) or non-uniform, e.g., when compensation is performed in response to estimated pixel brightness falling below a threshold. At T0, the pixels begin degrading in the same manner as in FIG. 5B, following the luminance curve 506. In contrast to the example in FIG. 5B, the compensation in FIG. 10 does not bring the pixels back to 100% of the initial brightness 510. For example, each of the compensation operations at T1, T2, and T3 may increase the brightness of the pixels by half of a difference 1005 between the initial brightness 510 and the brightness of the pixels at the time of the compensation.

It should be noted that the luminance curves shown in the drawings represent maximum possible brightness. The actual brightness of a display pixel depends on the input image being displayed, since each display pixel is set to a brightness of a corresponding pixel in the input image. Thus, the initial brightness level 510 may correspond to the brightness of a non-degraded pixel when the pixel is set to the highest brightness level (e.g., grayscale 255 or white) Likewise, the difference 1005 may correspond to a difference between the maximum possible initial brightness and the maximum possible brightness of a pixel at the time of a compensation operation.

Increasing the brightness to a level less than 100% of the initial brightness may reduce the appearance of ghost images when performed in conjunction with global compensation. Because every pixel is compensated using the same compensation parameter, a 100% adjustment may result in some pixels being severely overcompensated (too bright) and other pixels being severely undercompensated (too dark). Therefore, 100% adjustment could potentially create undesirable brightness contrasts that make a ghost image (essentially the inverse of a burn-in image) especially noticeable. By performing a less than 100% adjustment (e.g., 50% or some other fraction of the difference 1005), there will be less of such contrast, and ghost images will be less noticeable compared to global compensation at 100%. Ghost images are also expected to be less noticeable compared to pure block-averaging based compensation such as depicted in FIG. 7.

Another technique that can improve the quality of the output image is to gradually transition between compensation parameters, e.g., when the user's eye moves to another location. Referring back to FIG. 8A, if the user is currently looking at region 805, then the compensation parameter assigned to region 805 may be globally applied to every pixel to generate an output image for display. If the user's gaze moves to region 807, then the compensation parameter assigned to region 807 will be applied instead. However, switching immediately to a different compensation parameter can potentially cause flickering. Therefore, in some embodiments, a transition between compensation parameters is performed gradually. The transition may involve increasing or decreasing the brightness by a fixed increment (e.g., one grayscale level each time an image frame is output) until the next compensation parameter is reached.

Alternatively, the transition may be performed according to a mathematical function determined through interpolation across a certain time interval, e.g., linear, polynomial, or spline interpolation over a one-second interval. The time interval of the interpolation may represent a time period over which a series of adjustments is performed to achieve the transition. The interpolation can be performed between the current compensation parameter and the next compensation parameter or, alternatively, between some variable associated with the compensation parameters, such as grayscale level or drive current level. Thus, the interpolation can be performed with respect to values that apply to all pixels or values that are specific to individual pixels. Further, in some embodiments, the time interval for the interpolation may vary based on eye-tracking. For example, the time interval can be shortened during periods of rapid eye movement and lengthened during periods of slow eye movement.

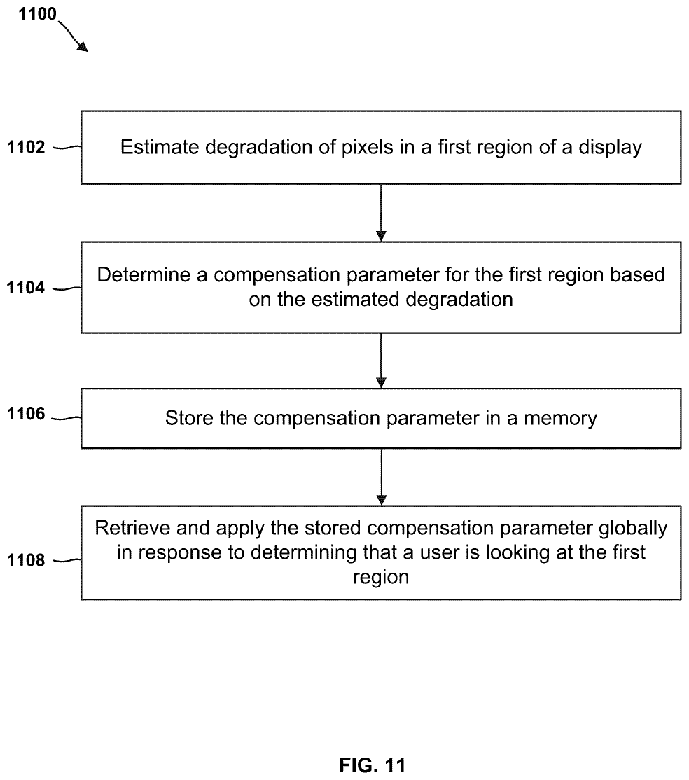

FIG. 11 is a flow diagram of a process 1100 for burn-in compensation, according to certain embodiments. Process 1100 can be performed using a display controller of a display system, e.g., the display driver 310 in FIG. 3. At 1102, the degradation of pixels in a first region of a display (e.g., one of the regions 801-809 in FIG. 8A) is estimated. The functionality in block 1102 may involve the display controller executing a prediction algorithm or applying a model to estimate the extent of the brightness loss for each pixel in the first region, based on one or more factors that are known to contribute to burn-in. For example, to estimate the degradation, the display driver 310 may process historical data regarding how long each pixel has been used (e.g., number of hours of on-time), usage frequency (e.g., average on-time), and the brightness of the image data 308 (e.g., average luminance or grayscale value for each pixel over the course of multiple image frames). In some embodiments, the estimation in block 1102 is performed for all regions of the display concurrently. The estimation can be performed according to a set interval, e.g., once per image frame or once every minute.

At block 1104, a compensation parameter (e.g., stress value) is determined for the first region based on the estimated degradation. The compensation parameter has a value that depends on the degradation of each pixel in the first region and can be determined through block-averaging. For example, the display driver 310 may compute a compensation parameter for each pixel in the first region and then compute the compensation parameter for the first region as an average of the compensation parameters of the individual pixels. Depending on the block size, the first region may include multiple blocks, in which case the compensation parameter for the first region may be determined by combining average values from different blocks in the first region. Although a separate compensation parameter may be determined for each pixel, the pixel-specific compensation parameters need not be stored. Instead, at block 1106, the compensation parameter for the first region may be stored in a memory accessible to the display controller.

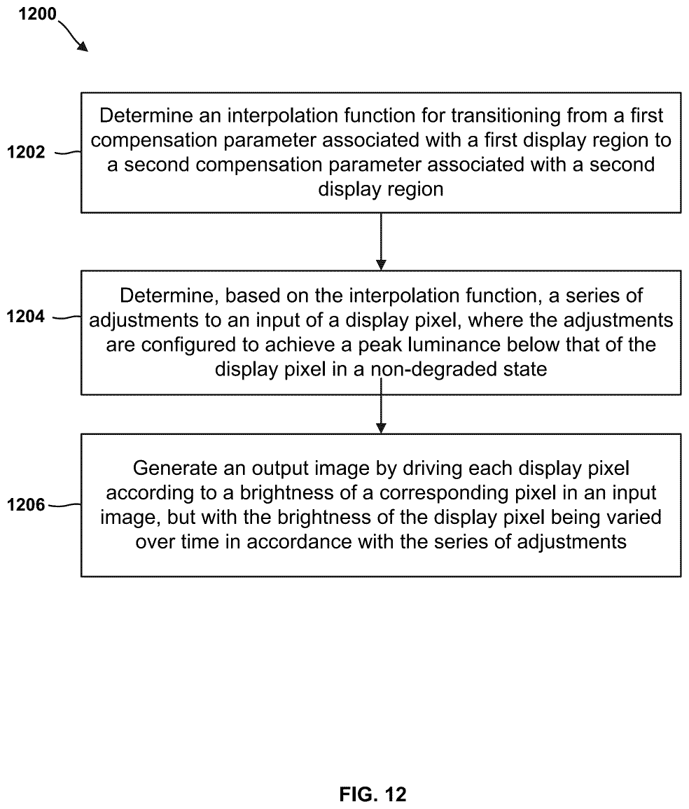

At block 1108, the compensation parameter for the first region is retrieved from memory and applied globally to every display pixel, in response to a determination that the user is looking at the first region. As discussed above, the display driver 310 may receive eye-tracking information 312 indicating where the user is currently looking. In the situation where the user's eyes remain stationary, e.g., when the user is fixed upon the first region over two or more tracking updates, the compensation parameter for the first region may already be applied, so no further compensation is needed. Therefore, the functionality in block 1108 can be performed when the user switches from viewing another display region to viewing the first region. The compensation parameter for the first region is applied to determine the extent to which the inputs to the display pixels are to be adjusted (e.g., increased). As discussed above and also in further detail below in connection with FIG. 12, a switchover to a different compensation parameter (e.g., that of the first region) can be performed gradually to avoid flickering.

FIG. 12 is a flow diagram of a process 1200 for switching between compensation parameters, according to certain embodiments. Process 1200 can be performed using display controller of a display system, e.g., the display driver 310 in FIG. 3. At 1202, an interpolation function is determined for use in transitioning from a first compensation parameter to a second compensation parameter. The first compensation parameter is associated with a first display region (e.g., one of the display regions 801-809), whereas the second compensation parameter is associated with a second display region (e.g., another one of the display regions 801-809). The first compensation parameter and the second compensation parameter have values that were determined earlier and stored in memory, e.g., in accordance with the process 1100 in FIG. 11.

The processing to determine the interpolation function may involve linear interpolation, cubic interpolation, spline interpolation, or some other interpolation technique. The interpolation function governs the transition from the first compensation parameter to the second compensation parameter over the course of some time interval, e.g., a duration specified in terms of number of image frames or clock time. For instance, the display driver 310 may perform bilinear interpolation, using a combination of linear interpolation along the time axis and linear interpolation along the compensation parameter axis.

At block 1204, a series of adjustments is determined based on the interpolation function from block 1202. The series of adjustments may comprise incremental adjustments to an input of a display pixel, e.g., incrementing/decrementing a drive current or voltage. As discussed above in connection with FIG. 10, adjustments may be configured to compensate a pixel to less than 100% of its initial brightness. Accordingly, the series of adjustments may be configured to achieve a peak luminance (maximum possible brightness) below that of the display pixel in a non-degraded state. For example, the series of adjustments may ultimately increase the drive current to a current level that achieves a peak luminance halfway between the initial brightness 510 and a peak luminance of the pixels in the second display region, i.e., the region associated with the next compensation parameter.

At block 1206, an output image is generated by driving each display pixel according to a brightness of a corresponding pixel in an input image, except that the brightness of each display pixel is varied over time in accordance with the series of adjustments determined in block 1204. Thus, each display pixel is set to display a respective portion of the input image, but the brightness is globally adjusted as part of transitioning from the first compensation parameter to the second compensation parameter. Additionally, the series of adjustments may carry over to a subsequent output image if the input image is updated during the time allotted for the series of adjustments, e.g., a duration corresponding to the time interval over which the interpolation was performed in block 1202.

The embodiments described herein may be used in conjunction with various technologies. For example, embodiments may be used in an artificial reality system environment, as discussed above. An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through).

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

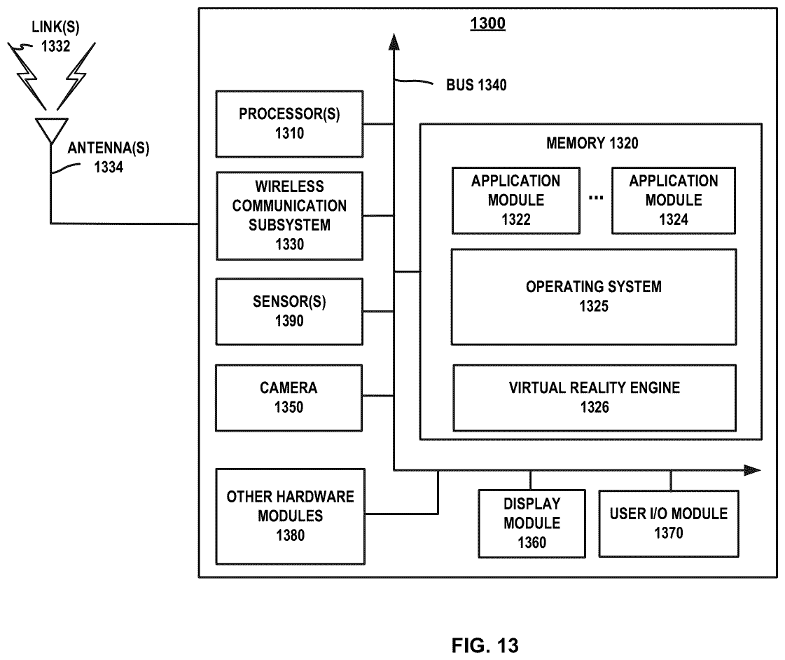

FIG. 13 is a block diagram of an example electronic system 1300 usable for implementing one or more of the embodiments disclosed herein. For example, electronic system 1300 may correspond to a near-eye display (e.g., HMD) and/or a console in an artificial reality system environment such as that depicted in FIG. 1. Electronic system 1300 may include one or more processor(s) 1310 and a memory 1320. Processor(s) 1310 may be configured to execute instructions for performing operations at a number of components, and can be, for example, a general-purpose processor or microprocessor suitable for implementation within a portable electronic device. In some embodiments, at least some of the processor(s) 1310 are embedded on a SoC integrated circuit. Processor(s) 1310 may be communicatively coupled with a plurality of components within electronic system 1300. To realize this communicative coupling, processor(s) 1310 may communicate with the other illustrated components across a bus 1340. Bus 1340 may be any subsystem adapted to transfer data within electronic system 1300. Bus 1340 may include a plurality of computer buses and additional circuitry to transfer data.

Memory 1320 may be coupled to processor(s) 1310. In some embodiments, memory 1320 may offer both short-term and long-term storage and may be divided into several units. Memory 1320 may be volatile, such as static random access memory (SRAM) and/or dynamic random access memory (DRAM) and/or non-volatile, such as read-only memory (ROM), flash memory, and the like. Furthermore, memory 1320 may include removable storage devices, such as secure digital (SD) cards. Memory 1320 may provide storage of computer-readable instructions, data structures, software modules, and other data for electronic system 1300. In some embodiments, memory 1320 may be distributed into different hardware modules. A set of instructions and/or code may be stored on memory 1320. The instructions can take the form of executable code, source code, and/or installable code.

In some embodiments, memory 1320 may store a plurality of application modules 1322 to 1324, which may include any number of applications. Examples of applications may include gaming applications, conferencing applications, video playback applications, or other suitable applications. The applications may include a depth sensing function or eye tracking function. Application modules 1322-1324 may include particular instructions to be executed by processor(s) 1310. In some embodiments, certain applications or parts of application modules 1322-1324 may be executable by other hardware modules 1380. In certain embodiments, memory 1320 may additionally include secure memory, which may include additional security controls to prevent copying or other unauthorized access to secure information.

In some embodiments, memory 1320 may include an operating system 1325 loaded therein. Operating system 1325 may be operable to initiate the execution of the instructions provided by application modules 1322-1324 and/or manage other hardware modules 1380 as well as interfaces with a wireless communication subsystem 1330 which may include one or more wireless transceivers. Operating system 1325 may be adapted to perform other operations across the components of electronic system 1300 including threading, resource management, data storage control and other similar functionality.

Wireless communication subsystem 1330 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1300 may include one or more antennas 1334 for wireless communication as part of wireless communication subsystem 1330 or as a separate component coupled to any portion of the system. Depending on desired functionality, wireless communication subsystem 1330 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other type of network. The techniques described herein may also be used for any combination of WWAN, WLAN, and/or WPAN. Wireless communications subsystem 1330 may permit data to be exchanged with a network, other computer systems, and/or any other devices described herein. Wireless communication subsystem 1330 may include a means for transmitting or receiving data, such as identifiers of HMD devices, position data, a geographic map, a heat map, photos, or videos, using antenna(s) 1334 and wireless link(s) 1332. Wireless communication subsystem 1330, processor(s) 1310, and memory 1320 may together comprise at least a part of one or more of a means for performing some functions disclosed herein.

Electronic system 1300 may include one or more sensors 1390. Sensor(s) 1390 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 1390 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or any combination thereof. The position sensors may be located external to the IMU, internal to the IMU, or any combination thereof. At least some sensors may use a structured light pattern for sensing.

Electronic system 1300 may include a display module 1360. Display module 1360 can be a near-eye display and may graphically present information, such as images, videos, and instructions, from electronic system 1300 to a user. Such information may be derived from one or more application modules 1322-1324, virtual reality engine 1326, one or more other hardware modules 1380, a combination thereof, or any other suitable means for generating graphical content for presentation to the user. Display module 1360 may use LCD technology, LED technology, light emitting polymer display (LPD) technology, or some other display technology. In some embodiments, display module 1360 may include a display driver/controller configured to perform burn-in compensation in accordance with the techniques described above.

Electronic system 1300 may include a user input/output module 1370. User input/output module 1370 may allow a user to send action requests to electronic system 1300. An action request may be a request to perform a particular action. For example, an action request may be to start or end an application or to perform a particular action within the application. User input/output module 1370 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1300. In some embodiments, user input/output module 1370 may provide haptic feedback to the user in accordance with instructions received from electronic system 1300. For example, the haptic feedback may be provided when an action request is received or has been performed.

Electronic system 1300 may include a camera 1350 that can be used to take photos or videos of a user, for example, for tracking the user's eye position. Camera 1350 may also be used to take photos or videos of the environment, for example, for VR, AR, or MR applications. Camera 1350 may include, for example, a complementary metal-oxide-semiconductor (CMOS) image sensor with a few millions or tens of millions of pixels. In some implementations, camera 1350 may include two or more cameras that may be used to capture three-dimensional images.

In some embodiments, electronic system 1300 may include a plurality of other hardware modules 1380. A hardware module 1380 may be a physical module within electronic system 1300. Some hardware modules 1380 may be temporarily configured to perform specific functions or temporarily activated. Hardware modules 1380 may include, for example, an audio output and/or input module (e.g., a microphone or speaker), a near field communication (NFC) module, a rechargeable battery, a battery management system, a wired/wireless battery charging system, and/or the like. In some embodiments, one or more functions of hardware modules 1380 may be implemented in software.

In some embodiments, memory 1320 may store a virtual reality engine 1326. Virtual reality engine 1326 may execute applications within electronic system 1300 and receive position information, acceleration information, velocity information, predicted future positions, or any combination thereof from various sensors 1390. In some embodiments, the information received by virtual reality engine 1326 may be used for producing a signal (e.g., display instructions) to display module 1360. For example, if the received information indicates that the user has looked to the left, virtual reality engine 1326 may generate content for the display module 1360 that mirrors the user's eye movement in a virtual environment. Additionally, virtual reality engine 1326 may perform an action within an application in response to an action request received from user input/output module 1370 and provide feedback to the user. The provided feedback may be visual, audible, or haptic feedback. In some implementations, processor(s) 1310 may include one or more GPUs that execute virtual reality engine 1326.

In various implementations, the above-described hardware and modules may be implemented on a single device or on multiple devices that can communicate with one another using wired or wireless connections. For example, in some implementations, some components or modules, such as GPUs, virtual reality engine 1326, and applications (e.g., an eye-tracking application), may be implemented on a console separate from the near-eye display. In some implementations, one console may be connected to or support more than one near-eye display.

In alternative configurations, different and/or additional components may be included in electronic system 1300. Similarly, functionality of one or more of the components can be distributed among the components in a manner different from the manner described above. For example, in some embodiments, electronic system 1300 may be modified to include other system environments, such as an augmented reality system environment and/or mixed reality system environment.

In the present disclosure, for the purposes of explanation, specific details are set forth in order to provide a thorough understanding of the disclosed examples. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a software module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, etc.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A system, comprising:
a display screen with a plurality of display pixels distributed across two or more regions; and
a display controller comprising one or more processing units configured to:
receive an input image for display on the display screen; and
generate control signals that drive each display pixel according to a brightness of a corresponding pixel in the input image, wherein:
the control signals are adjusted based on a first compensation parameter that compensates for pixel degradation;
the first compensation parameter is associated with display pixels in a first region of the display screen; and
the one or more processing units are configured to apply the first compensation parameter globally across all pixels in the plurality of display pixels.

2. The system of claim 1, wherein the display controller is configured to:
select the first compensation parameter from among a set of compensation parameters stored in memory, wherein the first compensation parameter is selected based on the display controller determining that a user is looking at the first region.

3. The system of claim 2, wherein the display controller is configured to:
update the set of compensation parameters periodically based on estimates of pixel degradation, wherein the display controller updates the set of compensation parameters to include a separate compensation parameter for each region of the display screen.

4. The system of claim 2, further comprising:
an eye-tracking unit configured to monitor movement of an eye of the user across the two or more regions of the display screen.

5. The system of claim 2, wherein the display controller is configured to:
transition to the first compensation parameter from a second compensation parameter associated with display pixels in a second region of the display screen; and
determine a series of adjustments in connection with transitioning from the second compensation parameter to the first compensation parameter, wherein the series of adjustments is performed over a time period.

6. The system of claim 5, wherein to determine the series of adjustments, the display controller is configured to perform interpolation between the first compensation parameter and the second compensation parameter and across a time interval representing the time period over which the series of adjustments is performed.

7. The system of claim 1, wherein the display controller is configured to adjust the control signals such that a maximum possible brightness of the display pixels in the first region is greater than a maximum possible brightness absent any adjustment, but less than a maximum possible brightness when the display pixels in the first region are non-degraded.

8. The system of claim 7, wherein the display controller is configured to set the maximum possible brightness of the display pixels in the first region to halfway between the maximum possible brightness absent any adjustment and the maximum possible brightness when the display pixels in the first region are non-degraded.

9. The system of claim 1, wherein the display controller is configured to compute the first compensation parameter through block-averaging with respect to the display pixels in the first region.

10. The system of claim 1, wherein the display controller is configured to:
rescale a gamma curve that maps possible brightness values to corresponding control signal values, wherein the gamma curve is rescaled to account for pixel degradation and such that a total number of possible brightness values is kept fixed; and
generate the control signals in accordance with the rescaled gamma curve.

11. A method comprising:
receiving, by a display controller, an input image for display on a display screen with a plurality of display pixels distributed across two or more regions;
generating, by the display controller, control signals that drive each display pixel according to a brightness of a corresponding pixel in the input image; and
adjusting, by the display controller, the control signals based on a first compensation parameter that compensates for pixel degradation, wherein the first compensation parameter is associated with display pixels in a first region of the display screen, and wherein the first compensation parameter is applied globally across all pixels in the plurality of display pixels.

12. The method of claim 11, further comprising:
determining, by the display controller, that a user is looking at the first region; and
selecting, by the display controller, the first compensation parameter from among a set of compensation parameters stored in memory, based on the determination that the user is looking at the first region.

13. The method of claim 12, wherein the determination that the user is looking at the first region is performed based on communication between the display controller and an eye-tracking unit that monitors movement of an eye of the user across the two or more regions of the display screen.

14. The method of claim 12, further comprising:
transitioning to the first compensation parameter from a second compensation parameter associated with display pixels in a second region of the display screen; and
determining, by the display controller, a series of adjustments in connection with transitioning from the second compensation parameter to the first compensation parameter, wherein the series of adjustments is performed over a time period.

15. The method of claim 14, wherein determining the series of adjustments comprises performing interpolation between the first compensation parameter and the second compensation parameter and across a time interval representing the time period over which the series of adjustments is performed.

16. The method of claim 11, wherein the control signals are adjusted such that a maximum possible brightness of the display pixels in the first region is greater than a maximum possible brightness absent any adjustment, but less than a maximum possible brightness when the display pixels in the first region are non-degraded.

17. The method of claim 16, further comprising:
setting the maximum possible brightness of the display pixels in the first region to halfway between the maximum possible brightness absent any adjustment and the maximum possible brightness when the display pixels in the first region are non-degraded.

18. The method of claim 11, further comprising:
computing the first compensation parameter through block-averaging with respect to the display pixels in the first region.

19. The method of claim 11, further comprising:
rescaling, by the display controller, a gamma curve that maps possible brightness values to corresponding control signal values, wherein the gamma curve is rescaled to account for pixel degradation and such that a total number of possible brightness values is kept fixed, and wherein the control signals are generated in accordance with the rescaled gamma curve.

20. A non-transitory computer-readable medium storing instructions that, when executed by one or more processors of a display controller, cause the display controller to perform the method of claim 11.
